(19) United States
(12) Patent Application Publication
(10) Pub. No.: US 2010/0315235 A1
(43) Pub. Date: Dec. 16, 2010

(54) GPS Security Network and Tracking System

(76) Inventors: Matthew Adegoke, Columbus, OH (US); David Robb, Lancaster, OH (US)

Correspondence Address: PORTER WRIGHT MORRIS & ARTHUR, LLP;INTELLECTUAL PROPERTY GROUP, 41 SOUTH HIGH STREET, 28TH FLOOR, COLUMBUS, OH, 43215, US

(21) Appl. No.: 12/797,380

(22) Filed: Jun. 9, 2010

Related U.S. Application Data
(60) Provisional application No. 61/186,237, filed on Jun. 11, 2009.

(51) Int. Cl. G08B 13/14

(52) U.S. Cl. 340/568.1; 340/573.4

(57) ABSTRACT

An object tracking and alarm system comprising a geographic position signaling unit securely attached to the object and wirelessly interconnected to a monitoring station, an alarm pad and a base. The unit continually transmits the geographic position of the object to the monitoring station. The system transmits an alert, which can be deactivated, to the monitoring station when the unit is located farther that a preset distance from the base and a surveillance camera, an alarm, and/or a system to notify law enforcement and the user are activated. If the alert has not been deactivated and the object is moved to a location greater than the preset distance from the base, the system transmits the alert to the monitoring station, which continuously monitors and transmits updates the geographic position of the object.

### CROSS-REFERENCES TO RELATED APPLICATIONS

The present application is a continuation of and claims priority to provisional patent application No. 61/186,237 filed 06-11-2009 titled GPS Security Network And Tracking System.

### FIELD OF THE INVENTION

The invention relates generally to tracking systems and more specifically to tracking systems that provide an alert when a personal item is moved without authorization.

### BACKGROUND OF THE INVENTION

Systems and methods for wireless asset tracking are known in the art. U.S. Pat. No. 6,977,612 to Bennett discloses a system and method employing a combination of long range and short range asset location systems using a GPS-based system combined with an RFID-based system. The short range system regularly activates itself, or is remotely polled, to determine if the asset is within range of the short range transceivers and long range system transceiver. In at least some embodiments, the asset is an automobile equipped with both RFID and GPS-based transceiver.

U.S. Pat. No. 6,415,542 to Bates discloses location-based firearm discharge prevention utilizing an onboard location sensor (e.g., a GPS receiver) and store location information to selectively inhibit discharge of a firearm based on the current location of the firearm. Location information identifying one or more prohibited locations is stored in the firearm (typically in an on-board memory). A controller on-board the firearm then accesses the location sensor to determine the current location is proximate any prohibited location.

U.S. Pat. No. 5,825,283 to Camhi titled System for the Security and Auditing of Persons and Property, discloses an apparatus for monitoring subjects with a location determining device that provides the location of the subject to a processor. The processor is configured to monitor the subject's location with respect to pre-define safety or security related limits including geographical boundaries, and to alert concerned individuals so that proper corrective action may be taken. The geographical boundaries may be programmed remotely by authorized personnel via a communication link. Additionally, processor inputs may be coupled to other systems, equipment or sensors in order to monitor operational variables or outputs of the coupled devices indicative or safety security concerns. Furthermore, processor outputs may be couple to other systems, equipment, or output devices, in order to actuate the coupled devices. Moreover, the processor has memory to enable storage and retrieval of data generated or received by the processor. Additional, the device may be configured to provide interactivity with the user to allow user correction of adverse conditions for review by a monitoring authority.

U.S. Pat. Application No. 2008/0074265 to Schoen titled System and Method to Protect Personal Property discloses an electronic tag associated with a personal property item. The system may also include a controller adapted to wireless communicate with the electronic tag to determine a status of the electronics tag to protect the personal item from loss or theft.

U.S. Pat. Application No. 2005/0070297 to Caspi titled System and Method for presence alarming discloses a telecommunications system includes a base device (150) including a positioning controller (504) and a communications controller (502), and base device adapted to cause an audible warning to be generated if said base device is determined to be outside a first predetermine range; and an administrative device (30-152) for receiving alerts from said wireless communications device via said communications controller when said positioning controller determines that said base device is outside first predetermine range for longer than a predetermine period or is outside said first predetermine range and a second predetermine range.

U.S. Pat. Application No. 2005/0066567 to Newkirk titled Gun with user notification discloses a gun having conventional components and a holster. The gun has means for detecting removal of the gun from the holster, means for processing the output of the detection means, and means for authenticating the user of the gun. The gun has means for notifying remote authorities that the gun has been removed from the holster, means for receiving remote commands to lock the trigger and/or initiate a global positioning system. The gun has means for selectively locking the trigger from a remote location and means for selectively activating a global positioning system from the remote location.

U.S. Pat. Application No. 2005/02589858 to Lai titled Personal Emergency locator transmitter (ELT) apparatus discloses a disguised emergency locator transmitter device for kids, works as a Lojack® (U.S. Trademark Registration No. 2690539 to LOJACK OPERATING COMPANY LP, WESTWOOD MASSACHUSETTS) locator for cars, and is installed inside kids' belongings, such as clothes, small toys, dolls and handheld electronics LCD video games (or as LCD video game cartridges) with built-in GPS receiver and cellular phone for locating kids in case of emergency. Preprogrammed phone numbers such as 911 or parents' phone numbers are dialed with location information when the ELT is power and activated by recognizing the keystrokes, voice commands or located by GPD and/or triangulation of the cellular phone or paging base-station tower.

While each of these patents/applications are related to security systems, there is a recognized need for improved home security and local authority response capability in regards to a home invasion, theft or unauthorized use of a firearm (gun). Thus, giving the consumer the ability to purchase the home security network at local retailers, instead of using traditional home security methods, providing the consumer with a relative low cost solution and do it yourself installation system.

There are currently no reliable means to protect an individual's personal property from theft; rather we have an entirely different type of asset location, such as that used for locating stolen vehicles. A commonly known system of this type is the LoJack® system described above and in U.S. Pat. Nos. 4,818,998, 4,908,629, 5,917,423, and 6,665,613, all of which in general terms, this type of system uses a remotely activated system to track a vehicle in motion, using transceivers installed in the target vehicle in combination with transceiver/detectors mounted on other vehicles. The prior art that describes alarms and tracking systems, such as U.S. Pat. No. 5,731,785, which describes a single signaling unit carried by an individual, object, or vehicle, all suffer from at least two fundamental deficiencies. If the signaling unit is separated from the individual, object, or vehicle, tracking is no longer possible. Moreover, prior art systems fail to address loss of signals and false alarms.

Another type of long-range tracking system uses global positioning satellites (GPS) to identify the current location of an asset. These systems are exemplified by U.S. Pat. No. 6,510,380, security and tracking apparatus with a first signaling unit having means for identifying the location of a signaling unit is in communication with a second signaling unit. This system fails to address the circumstance that may arise in case of abduction or aggravated invasions whereby a thief takes away both signaling units. Because prior signaling units do not recognize that there is a difference between primary and secondary proximity, the communication units are lacking because they do not alert monitoring stations when both units are in motion because both units communicate directly with satellites.

Firearms, such as handguns, hunting rifles, shotguns and other weapons, have a number of lawful uses, including self-defense, hunting, law enforcement and military uses. However, due to the extremely dangerous nature of firearms, a significant concern also exists as to other, improper uses of firearms.

It is extremely useful to be able to automatically and continually identify the location of an object or a person. It would have been helpful if the firearm in the Virginia Tech massacre was equipped with a weapon tracker (a “smart gun”). The event consisted of two separate attacks approximately two hours apart on Apr. 16, 2007, that took place on the campus of Virginia Polytechnic Institute and State University (Virginia Tech) in Blacksburg, Virginia, United States. The perpetrator killed 32 people and wounded many others before committing suicide. The massacre is the deadliest peace time shooting incident by a single gunman in United States history, on or off a school campus. Almost two hours after the first killings, the perpetrator appeared at a nearby Post Office and mailed a package of writings and video recordings to NBC News. The package was postmarked 9:01 AM. He then walked to the site of the second set of murders. In a backpack, he carried several chains, locks, a hammer, a knife, two guns, and almost 400 rounds of ammunition. If the weapons used in the massacre had been equipped with a weapon tracker as described herein, then the system could have transmitted the location of each signaling unit in each weapon automatically, allowing the initiation of a signal for activating the transmission of information identifying the perpetrator, and possibly minimizing or preventing the numbers of deaths.

While conventional smart gun technologies address a number of the concerns associated with improper firearm usage, additional concerns still remain. For example, an authorized owner or operator of a firearm is still capable of using the firearm for unlawful purposes. As such, an authorized owner of a firearm could use a firearm in a crime if he or she so desired. In addition, firearms that are required to be within receiving distance of a transmitter could still be actuated if an unauthorized person was also able to obtain the transmitter from the authorized owner. No prior art provides the technology to retrofit firearms already in the market.

Therefore, a significant need continues to exist for an improved GPS home security tracking system that alerts a user when personal objects are relocated from an identified location and allow firearm tracking and prevents discharge of a firearm for unauthorized usage. A need exists for a method of tracking personal possessions, especially firearms, in a manner that is simpler, less expensive, and more flexible than conventional technology.

A need exists for a GPS security network and tracking system capable of reliably reporting the process of obtaining a gun time frame registration and depletion process on a weapon. Tracking weapons is of evident tactical value for improving the safety of innocent people, members of the military forces or members of the police departments. An authorized gun owner will have a simple referential indicator to help take safe action for registered and better management of their critical ammunition resources.

Finally, many prior art systems subject police officials to a period of vulnerability of false alarms. Moreover, prior art systems fail to address the circumstances of a professional thief or thieves or individuals who are helpless in an emergency situation such as abduction or kidnapping, or physical or mental incapacitation. Today existing security technology provides preprogrammed phone number such as 911 or voice command. This technology currently falls short in the case of weak wireless communications strength or the abductees' were separated from their device and in situations where there is no phone available. The importance of emergency response is demonstrated by the Federal Communications Commission (FCC) mandate, in two phases, of wireless 911 for the identification of a relevant public safety answering point. This mandate still falls short of necessary safety requirements in situations of abduction or kidnapping, physically or mentally depriving of strength or ability, and other emergency situations remote from available wireless communications. These situations require a security and tracking system that is not limited in range and is able to automatically trigger a security device, such as a camera, an alarm, etc when personal property is separated from a location at a predetermine range.

### SUMMARY OF THE INVENTION

A GPS security network and tracking system is provided, comprising a first signaling unit having means for identifying the location of said signaling unit, and a second signaling unit in communicating proximity with the cellular base, the second signaling unit having means for identifying the location of said second signaling unit. The system is interconnected to at least one cellular tower and at least one satellite.

In an embodiment, the present invention provides a GPS security and tracking system comprising a first signaling unit having means for identifying the location of said signaling unit, a second signaling unit in communicating proximity with the wireless device, the second signaling unit having means for identifying the location of said second signaling unit, and a monitoring station capable of receiving information identifying the location of the signaling units.

In an embodiment, the present invention provides security tracking system comprising a zone control display or alarm key pad component and at least one hidden camera. The GPS security network and tracking system comprises a zone control pad component in communicating proximity with the wireless device, such that when base units are outside of communicating proximity with the zone control component, an audible alert and/or silent alert is triggered and transmitted to or through a monitoring station, web site, mobile device and the like that activates a designated camera, alarm, call for help, etc.

In an embodiment, a network tracking system method is provided to locate a person, animal, or object, comprising and providing in contact with the person, animal, or object, at least two signaling units, a zone control display or alarm key pad component and a camera. Each signaling unit has means for identifying the location of signaling unit. Each signaling unit has means for activating the zone control display or alarm key pad component to trigger an alert to the monitoring station and designated camera. In an embodiment, the object is a firearm. In an embodiment, the signaling unit is hidden from sight. In an embodiment, the base is hidden from sight. In an embodiment, the base is disguised as a routine household object.

A network tracking system method is provided with a web based users' account login giving the user the ability to purchase the security network at local retailers, and use it independently of a traditional home security method, providing the consumer with a relative low monthly fees and do it yourself installation system.

In an embodiment, the present invention is an object tracking and alarm system comprising a geographic position satellite signaling unit securely attached to the object and wirelessly interconnected to a monitoring station and a wireless base. The wireless device continually transmits the geographic position of the object to the monitoring station. The unit is preprogrammed to transmit an alert to the monitoring station when the unit is located farther that a preset distance from the wireless device.

The wireless device comprises means to allow a user to deactivate the alert. If the alert has not been deactivated and the object is moved to a location greater than the preset distance from the wireless device, the unit transmits the alert to the monitoring station and the monitoring station activates at least one of the following: a) a surveillance camera, b) an alarm on an alarm key pad, and, c) a system to notify law enforcement and d) a system to notify the user. The system provides continuous object geographic position and transmits updates as the removed object is relocated.

In an embodiment, the system comprises means to communicate with the monitoring station, via a network, such as but not limited to via the internet, cellular, phone line, satellite and home alarm. The system can be set up in an existing security system or routed directly through broadband or a networked communications device.

The invention is an object tracking and alarm system comprising a geographic position signaling unit securely attached to the object and wirelessly interconnected to a monitoring station and a base. The signaling unit continually transmits the geographic position of the object to the monitoring station and the base unit is preprogrammed to transmit an alert to the monitoring station when the unit is located farther that a preset distance from the base. In an embodiment the system also alerts if the base is removed from a preset distance from the alarm pad. A user can set the system so that an alert will be triggered when a signaling unit or base is farther than a given number of feet, such as the perimeter of the house or property.

The system comprises means to allow a user to deactivate the alert. If the alert has not been deactivated and the object is moved to a location greater than the preset distance from the base, the unit transmits the alert to the monitoring station and the monitoring station activates an alarm. In an embodiment, the alarm is sent though an alarm key pad.

A user programs the system via one of 1) an alarm key pad and 2) a secure web site in a network interconnected to the base. The user deactivates the alert using one of the key pad and the web site. The system notifies the user of an alert via one of a phone, a pager, a text message, an email, or other communication device.

As used herein, “approximately” means within plus or minus 25% of the term it qualifies. The term “about” means between ½ and 2 times the term it qualifies.

The compositions and methods of the present invention can comprise, consist of, or consist essentially of the essential elements and limitations of the invention described herein, as well as any additional or optional components or limitations described herein or otherwise useful in systems and methods of the general type as described herein.

All references to singular characteristics or limitations of the present invention shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

### DRAWING FIGURES

FIG. 1 is a diagram of an embodiment of the present invention depicting the components of the GPS home security network system.

FIG. 2 is a diagram of an embodiment of the present invention showing communication requirements.

FIG. 3 is an illustration of an embodiment of the present invention displaying a GPS signaling unit attached to or embedded within a pistol firearm.

FIG. 4 is an illustration of an embodiment of the present invention displaying a GPS signaling unit attached to or embedded within a television.

FIG. 5 is a diagram of an embodiment of the present invention showing the GPS module weapon tracking device sitting stationary in communication with the wireless device in conjunction with the alarm pad component and camera reporting stationary signals back to a monitoring station.

FIG. 6 is a diagram of an embodiment of the present invention showing a GPS module thief tracking device sitting stationary in communication with the wireless device in conjunction with the alarm pad component and camera reporting stationary signals back to a monitoring station.

FIG. 7 is a diagram of an embodiment of the present invention depicting an unauthorized user with a GPS module weapon tracking device that is outside of proximity of the wireless device in communication with a satellite, with a panic alert being sent to a monitoring station. The monitoring station communicates the tracking information and alerts local authorities and authorized owner via a transmission device, such as a phone/cellphone, pager, PDA or other communication device.

FIG. 8 is a diagram of an embodiment of the present invention depicting an unauthorized user with a GPS module tracking device that is outside of proximity of the wireless device in communication with satellite so that a panic alert is sent to the monitoring station. The monitoring station communicates the tracking information and alerts local authorities and authorized owner via a transmission device, such as a phone/cellphone, etc. The movement outside the proximity of the thief tracking device zone limit triggers the zone control component that triggers an audible alert and/or silent alert detection from the zone control or alarm pad component to the camera. The camera will record for at least 1 hour once the alarm is triggered.

FIG. 9 is a diagram of an embodiment of the present invention depicting an unauthorized user with a GPS module weapon tracking device that is inside of the proximity zone of the wireless device. The wireless device is in constant communication with a cellular tower (when in range of a cellular tower) and a panic alert is sent to the monitoring station notifying of the identified movement. The monitoring station communicates the tracking information and alerts local authorities and authorized owner via a transmission device, such as a phone/cellphone, etc.

FIG. 10 is a diagram of an embodiment of the present invention depicting an unauthorized user with the GPS module tracking device that is inside of the proximity zone of the wireless device. The wireless device is in constant communication with the cellular tower (when in range of a cellular tower) and a panic alert is sent to a monitoring station of the unidentified movement. The monitoring station communicates the tracking information and alerts local authorities and the authorized owner via a transmission device, such as a phone/cell phone, etc. The movement outside the proximity zone of the thief tracking device triggers an audible alert and/or silent alert detection from the zone control or alarm pad component to the camera. The camera will record for a period of time, such as 1 hour, once the alarm is triggered.

FIG. 11 is a diagram of an embodiment of the present invention showing an authorized user with a GPS module weapon tracking device within proximity of the wireless device. The authorized user has clicked on “Going Out” on the website under his/her account (requiring a login). The wireless device continues to be tracked; however, there will be no alert sent because the user informed the monitoring station of the movement.

FIG. 12 is an illustration of the present invention showing the user Account Login link for a user to go into his/her account at the monitoring website located at www.mgaservice.com.

FIG. 13 is an illustration of the present invention showing the World Wide Web page once the user is logged into his/her account.

FIG. 14 is an illustration of the present invention showing the World Wide Web page where the user will activate his/her GPS module tracking device.

### DETAILED DESCRIPTION OF THE INVENTION

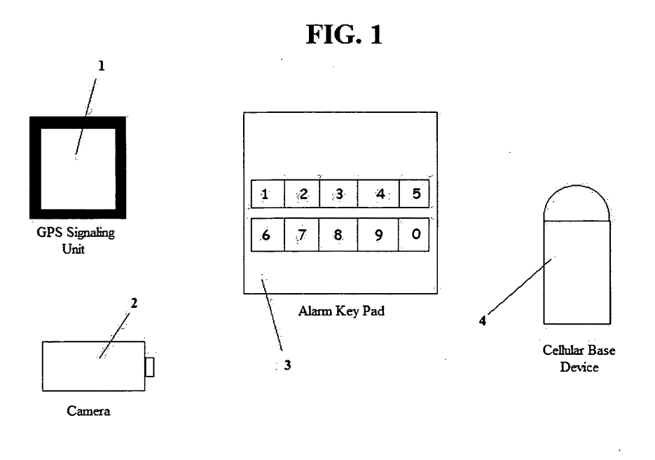

Referring to FIG. 1, the present invention is a GPS security network system and apparatus. There are at least 4 components that are used in conjunction with one another making up the GPS security network system and apparatus. The GPS signaling unit 1, has the means for identifying the location of signaling unit via a satellite (shown in other figures). The GPS signaling unit 1 is small and designed to be securely attached to an object hidden from view. The GPS signaling unit 1 is designed to be attached to personal items, such as but not limited to a television, a DVD/VCR, a painting or other work of art, jewelry, a gun or other weapon, a security safe, money, silver home goods, collectibles, and the like. Each signaling unit has the ability to 1) identify the location of the signaling unit(s) to a monitoring station (not shown); 2) updating the location of the signaling unit to the monitoring station by referencing the global positioning satellite (GPS) system and/or cellular GPS; and 3) notifying the monitoring station of a change in geographic location. The surveillance camera 2, provides an authorized user images and/or video footage. The surveillance camera 2 receives transmission signals from the zone control display or alarm key pad component 3, in response to asset/personal property movement. The alarm key pad 3, is an alternative method to activate and/or deactivate GPS signaling unit(s) 1, instead of using a network, such as the World Wide Web. The numeric key pad depiction in FIG. 1 is for illustration purposes only. One skilled in the art would understand that any input mechanism, such as alpha, icon, touch screen or any combination thereof would work in the present invention. The zone control display or alarm key pad component 3 is capable of receiving transmission of signals from wireless device 4. The wireless device (or base) 4 is located in communicating proximity with the GPS signaling unit(s) 1. The wireless device 4, device has means, such as a computer program, for deactivating the GPS signaling unit 1 within the proximity zone and the ability to identify the location of the wireless device 4 using cellular communication via GPS. The wireless device 4 is a rechargeable unit and may use a USB plug so it can be plugged into a personal computer. The unit 4 is useful for downloading updates for the GPS security network system from the authorized user's personal account page.

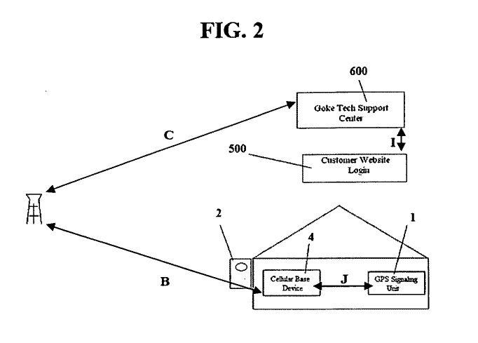

Referring to FIG. 2, the present invention is a GPS security network system and apparatus. The GPS signaling unit 1 having means for identifying the location of a signaling unit via satellite 800; and a wireless device signaling device 4 in communicating proximity with the first signaling unit 1. The second signaling device (base) 4 having means for deactivating the GPS signaling unit 1 within proximity and the ability to identify the location of the signaling unit using cellular communication via GPS.

In an embodiment, the GPS security network system and apparatus of the present invention includes means for transmitting the location of each signaling unit automatically when a signaling unit is separated more than a preselected distance from a base 4. The separation triggers an alarm (silent and or audible and or visual) sending a communication via cellular signal to a monitoring station 600. In addition to the separating signaling units, communication from the wireless device 4, is sent to the alarm key pad 3, and a signal is sent to surveillance camera(s) 2 to start recording video surveillance and/or capturing images. Tracking and video surveillance information and/or images are sent via signal to a predetermined device, such as a computer, and can be viewed in the user's personal account, provided the greatest possible degree of security, it is necessary for the system to signal immediately and automatically in the case of an emergency situation.

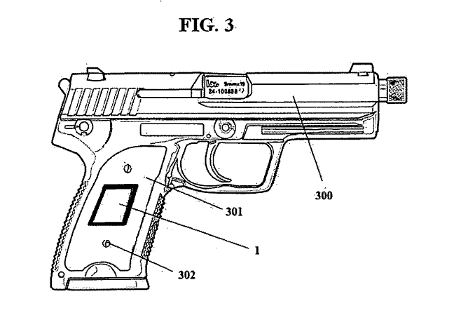

FIG. 3 depicts an embodiment of the present invention displaying a GPS signaling unit 1 located inside of a pistol or firearm 300. The GPS signaling unit 1, is attached to or imbedded in a pistol firearm 300. The GPS signaling unit 1, is placed by the authorized user in a hollow point inside the pistol grip plate 301. The authorized user loosens and removes the pistol grip plate screws 302. The authorized user then remove the pistol grip plate 301 and place the GPS signaling unit 1, securely in place. The authorized user then puts the pistol grip plate 301, back into position, securely fastens the pistol grip plate screws 302.

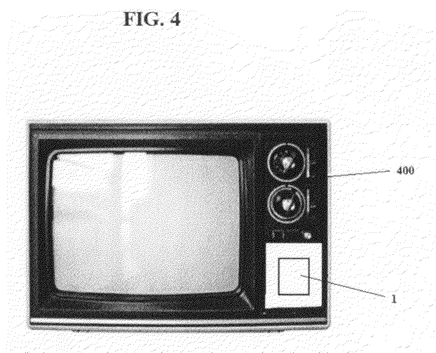

FIG. 4, depicts an embodiment of the present invention displaying a GPS signaling unit 1 located in or on a television 400. In an embodiment, the GPS signaling unit 1, is attached inside of the television 400. The authorized user secures the GPS signaling unit 1 inside the television 400 securely in place.

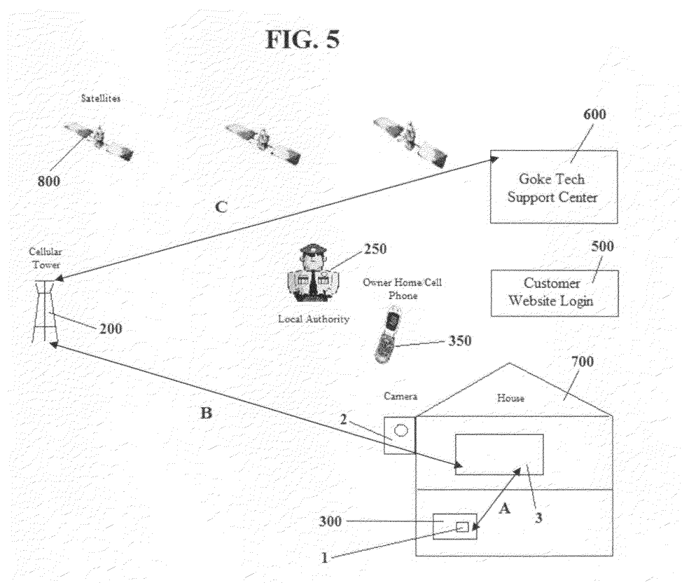

Referring to FIG. 5, this drawing provides the illustration of a firearm 300, with the GPS signaling unit 1, placed securely in the firearm 300, secured inside a house 700. The wireless device 4 and zone control display or alarm key pad component 3 is in direct communication via cellular signal B, to a cellular tower 200, the cellular tower 200 sends communication signal C, to a monitoring station or support center 600 (such as the Goke Technology Center). The system is depicted in sleep mode and does not report any alerts because all units are within the desired proximity chosen by the authorized user.

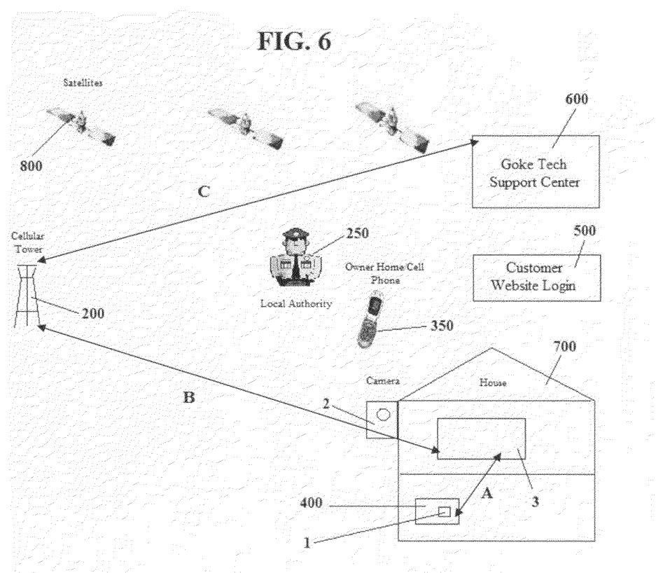

Referring to FIG. 6, this drawing provides the illustration of a television 400, with the GPS signaling unit 1, placed securely in the television 400, secured inside a house 700. The GPS signaling unit 1, is within pre-set proximity, sending communication signal A, to the wireless device 4 and alarm key pad 3. The wireless device 4 and alarm key pad 3, is in direct communication via cellular signal B, to a cellular tower 200, the cellular tower 200 sends communication signal C, to the support center 600. The system is depicted in sleep mode and does not report any alerts because all units are within the desired proximity chosen by the authorized user.

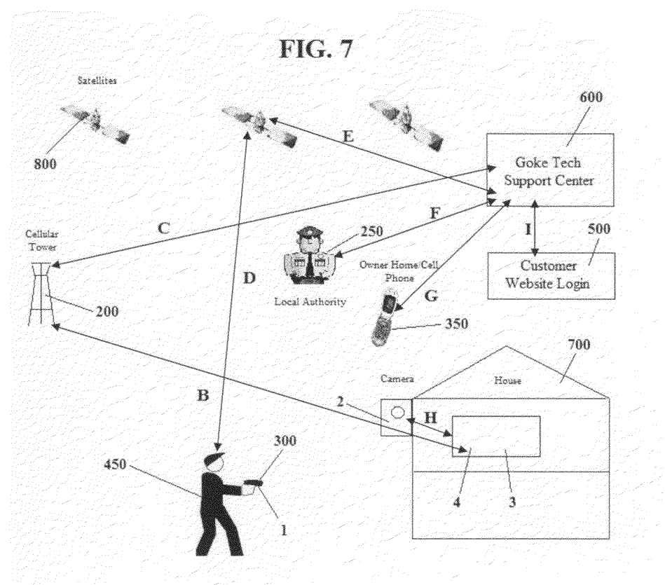

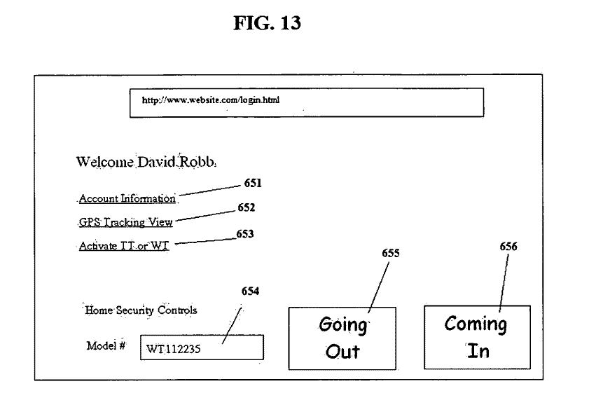

Referring to FIG. 7, this drawing provides the illustration of an unauthorized user 450 removing the firearm 300, that is equipped with a GPS signaling unit 1, the wireless device 4 and alarm key pad 3, sends communication B, to cellular tower 200, and alerts that the GPS signaling unit 1, is outside of pre-set proximity, the cellular tower 200 sends alert signal C, to support center 600. The alarm key pad 3, is triggered upon separation of the GPS signaling unit 1, and send communication H, to the surveillance camera 2, to start recording images. Satellites 800, locates the GPS signaling unit 1 through communication signal D, sending an alert signal E, to the support center 600. Support center 600 automatically transmits updates through communication I, to the authorized user's customer website account 500, and continuously provides tracking updates to authorities and or the user. The support center 600 contacts local authority 250, through communication F, and contacts the authorized user through a network or a communication device 350, through communication G, which are the numbers provided in the activation mode displayed in FIG. 13. In an embodiment, the monitoring station/support center 600 is the Goke Technology Support Center.

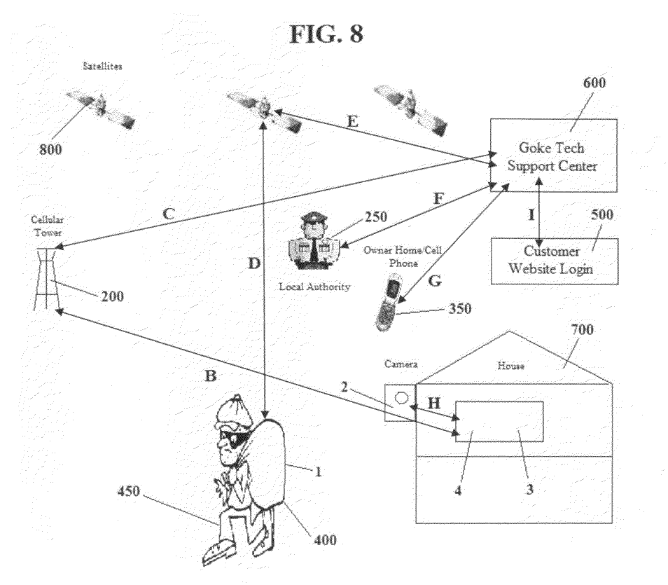

FIG. 8 provides the illustration of an unauthorized user 450 removing a television 400, that is equipped with a GPS signaling unit 1. The wireless device 4 and alarm key pad 3, send communication B, to cellular tower 200, as an alert that GPS signaling unit 1 is outside of pre-set proximity. The cellular tower 200 sends alert signal C, to the support center 600. The zone control display or alarm key pad component 3 is triggered upon separation of the GPS signaling unit 1 from the base 4, and send communication H to the surveillance camera 2 to start recording images. Satellites 800 locates through communication signal D, the GPS signaling unit 1, sending an alert signal E to the support center 600. The support center 600, automatically transmits updates through communication I, to the authorized user's customer website account 500, and continuously provides tracking updates. The support center 600 contacts local authority 250 through communication F and contacts the authorized user by a communication device 350, through communication G, as provided in the activation mode displayed in FIG. 13.

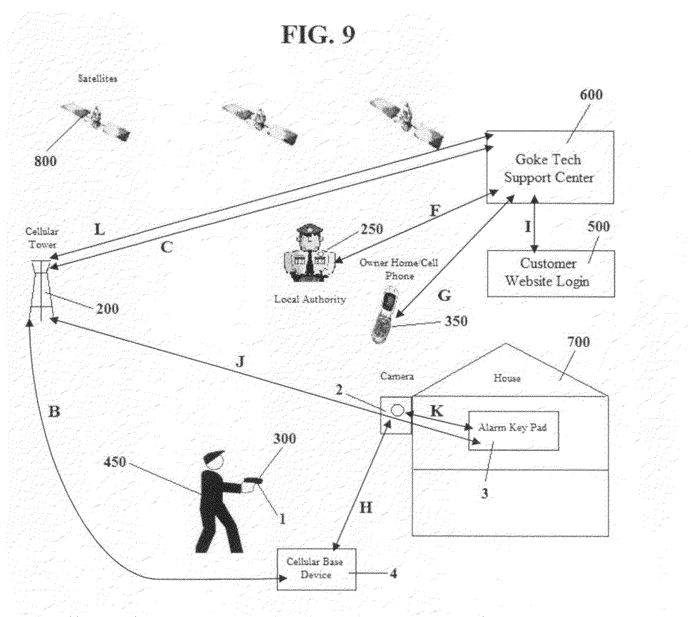

Referring to FIG. 9, an illustration of an unauthorized user 450 removing a firearm 300, that is equipped with a GPS signaling unit 1 is provided. The unauthorized user 450 found the wireless device 4, taking the device along with the firearm 300. The zone control display or alarm key pad component 3 sends communication J to cellular tower 200 and alerts that wireless device 4, is outside of pre-set proximity. The cellular tower 200 sends alert signal L to the support center 600. The zone control or alarm key pad component 3, is triggered upon separation of wireless device 4 and alarm key pad 3, sending communication H to the surveillance camera 2 to start recording images. Cellular tower 200 locates, through communication signal B, the wireless device 4, sending an alert signal C to the support center 600. The support center 600 automatically transmits updates, through communication I, to the authorized user's customer website account 500 and continuously provides tracking updates. The support center 600 contacts local authority 250, through communication F, and contacts the authorized user by network or communication device 350, through communication G, as provided in the activation mode displayed in FIG. 13.

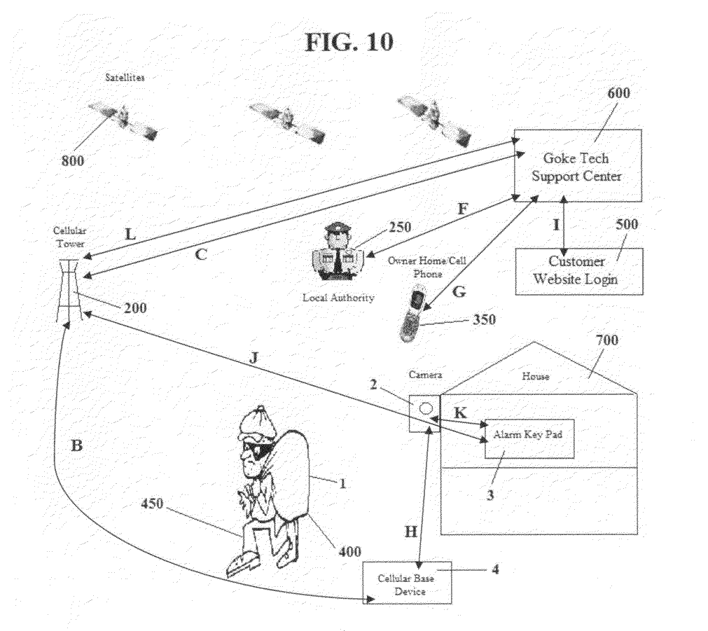

Referring to FIG. 10, this drawing provides the illustration of an unauthorized user 450 removing a television 400 that is equipped with a GPS signaling unit 1, the unauthorized user 450, found the wireless device 4, taking the device 4 along with the television 400. The zone control display or alarm key pad component 3 sends communication J to cellular tower 200 and alerts that wireless device 4 is outside of pre-set proximity zone. The cellular tower 200 sends alert signal L to the support center 600. The alarm key pad 3 is triggered upon separation of wireless device 4 and alarm key pad 3 sending communication H to the surveillance camera 2 to start recording images. Cellular tower 200, locates through communication signal B, the wireless device 4, sending an alert signal C to support center 600. The support center 600 automatically transmits updates, through communication I, to the authorized user's customer website login account 500, and continuously provides tracking updates. The support center 600 contacts local authority 250, through communication F, and contacts the authorized user by network or a communication device 350, through communication G, as provided in the activation mode displayed in FIG. 13.

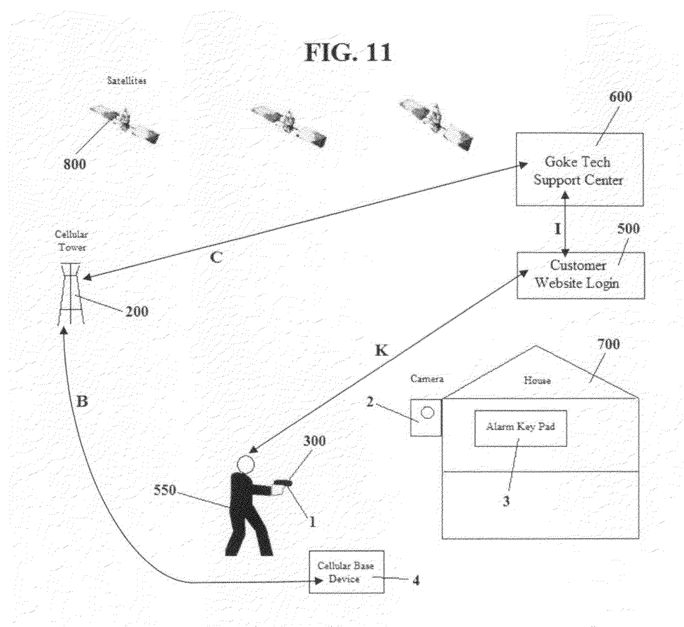

Referring to FIG. 11, this drawing provides the illustration of an authorized user 550 removing a firearm 300 that is equipped with a GPS signaling unit 1. The authorized user 550 has disabled the wireless device 4, using the “going out” button identified in FIG. 13, alerting support center 600 of taking the firearm 300 (and/or wireless device 4) outside of the proximity zone of the alarm key pad 3. Disabling can be either deactivating the preset distance alert from the GPS signaling unit 1 to the base 4 or increasing the preset distance from the signaling unit 1 to the base 4 or the base to the pad 3. If the GPS signaling unit 1 is within the desired pre-set proximity of the wireless device 4, the wireless device 4 is still continuously monitored and sending communication signal B to the cellular tower 200, which transmits tracking information through communication signal C to the support center 600. The support center 600 provides on-going tracking information to customer website account 500 through transmission signal I; however, no alerts are sent unless the authorized user 550 and/or an emergency contact listed on the authorized user's account 500 reports an emergency through communication signal K.

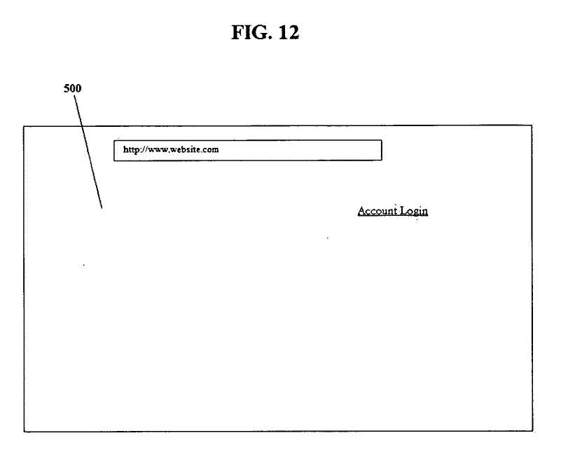

Referring to FIG. 12, an illustration of account login on a network, such as a website, is provided. The authorized user purchases the GPS security network system and apparatus at a local retail store, online or the like, and goes to website 500 and clicks on the link account login.

Referring to FIG. 13, this drawing provides an illustration of the user's personal account web page located at the monitoring center's protected website. Illustration 654, allows the authorized user to activate and deactivate the GPS signaling unit by model number, account codes and the like. The “going out” button 655 is selected by the authorized user to deactivate the GPS signaling unit for a particular object for notifying the support center 600 of removal of unit from the preset distance. The user may also remove the GPS signaling unit from the object when the system is deactivated. the authorized user selects the “coming in” button 656 to activate the GPS signaling unit to reactivate the signaling unit for assigned to that object.

The system includes a “time out” feature, where a user indicates a period of time that the signaling unit for a particular object is disabled. In an embodiment, the time frame is 15 days for a gun. The user keys in the time limit for the disabled signaling unit and the system notifies the support center 600.

At links 651-653, a user accesses additional fields to enter personal information after purchasing the security network system and apparatus in order to activate the GPS signaling unit(s). Link 652 allows the authorized user to access to view tracking information of the unit(s) provided in the security network system and apparatus. Link 651 allows the user to modify personal information under his or her account.

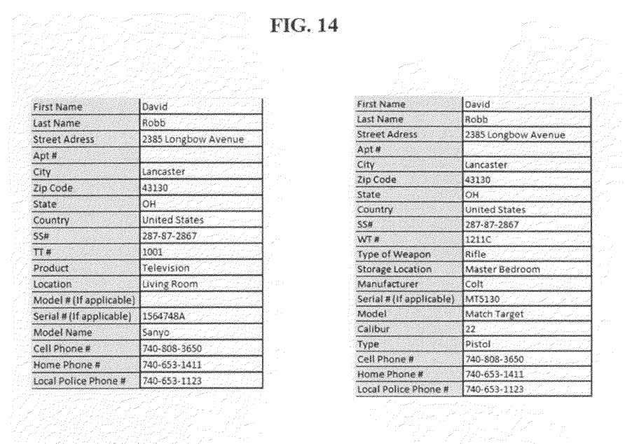

FIG. 14 is an illustration of data added at links 651 653 inputted by an authorized user/purchaser that has activated GPS signaling unit. The data is stored by the center. The user can input data for multiple GPS signaling units assigned to different objects.

The foregoing description of the invention has been presented for purposes of illustration and description. It is not intended to be exhaustive nor to limit the invention to the precise form disclosed. Many alternatives, modifications, and variations will be apparent to those skilled in the art. For instance, the present invention could be readily implemented for any entity, including businesses, or any other person or thing for which a security system is desired. Likewise, the invention is not limited to existing technologies. For example, the apparatus may use the future equivalent of a GPS system or cellular units. Accordingly, this invention is intended to embrace all alternatives, modifications, and variations that fall within the spirit and broad scope of the claims.

We claim:

1. An object tracking and alarm system comprising a geographic position signaling unit securely attached to the object and wirelessly interconnected to:
1) a monitoring station, said unit continually transmitting the geographic position of the object to the monitoring station; and
2) a base; the system preprogrammed to transmit an alert to the monitoring station when the unit is located farther that a preset distance from the base;
said system comprising means to allow a user to deactivate the alert, and wherein, if the alert has not been deactivated and the object is moved to a location having a distance greater than the preset distance from the base, the alert is transmitted to the monitoring station and the monitoring station activates an alarm.

2. The system of claim 1 wherein the object is one of a person, an animal, and a personal property.

3. The system of claim 1 wherein the object is a firearm.

4. The system of claim 1 wherein the signaling unit is hidden from sight.

5. The system of claim 1 wherein the base is hidden from sight.

6. The system of claim 1 wherein the base is disguised as a household object.

7. The system of claim 1 wherein the monitoring system is interconnected to at least one of a cellular tower, a satellite and a network.

8. The system of claim 1 wherein the alert activates at least one of the following: a) a surveillance camera, b) an audible or silent alarm, c) a system to notify law enforcement, and d) a system to notify the user.

9. The system of claim 1 wherein the alarm is sent though an alarm key pad that activates at least one of the following: a) a surveillance camera, b) an audible or silent alarm, c) a system to notify law enforcement, and d) a system to notify the user.

10. The system of claim 1 wherein the user programs the system via one of 1) an alarm key pad and 2) a secure web site in a network interconnected to the base.

11. The system of claim 10 wherein the user deactivates the alert using one of the key pad and the web site.

12. The system of claim 1 wherein the user is notified of an alert via one of a network, a phone, a pager, a text message, and an email.

13. An object tracking and alarm system comprising a geographic position signaling unit securely attached to the object and wirelessly interconnected to:
1) a monitoring station interconnected to at least one of a cellular tower, at satellite, and a network, said unit continually transmitting the geographic position of the object to the monitoring station;
2) an alarm pad; and
3) a base wirelessly interconnected to the signaling unit and the alarm pad, the system A) preprogrammed to transmit an alert to the monitoring station when i) the unit is located farther that a preset distance from the base, or ii) the base is located farther that a preset distance from the alarm pad, the alert activating at least one of the following: a) a surveillance camera, b) an audible or silent alarm, c) a system to notify law enforcement, and d) a system to notify a user, and B) comprising means to allow the user to deactivate the alert.

14. The system of claim 13 wherein the object is a firearm.

15. The system of claim 13 wherein at least one of the signaling unit and the base unit is hidden from sight.

16. The system of claim 13 wherein the base is disguised as a household object.

17. The system of claim 13 wherein the user programs the system via one of 1) an alarm key pad and 2) a secure web site in a network interconnected to the base.

18. The system of claim 18 wherein the user deactivates the alert using one of the key pad and the web site.

19. The system of claim 13 wherein the user is notified of an alert via one of a network, a phone, a pager, a text message, and an email.
